(19) United States
(12) Patent Application Publication
(10) Pub. No.: US 2025/0063589 A1
(43) Pub. Date: Feb. 20, 2025

(54) SCHEDULING WITH A SPLIT SYMBOL FOR BEAM MANAGEMENT

(71) Applicant: QUALCOMM Incorporated, San Diego, CA (US)

(72) Inventors: Kang GAO, San Diego, CA (US); Yongle WU, San Diego, CA (US); Jun ZHU, San Diego, CA (US); Derrick Albert CHU, San Diego, CA (US); Vasanthan RAGHAVAN, West Windsor Township, NJ (US); Yong LI, San Diego, CA (US); Ruhua HE, San Diego, CA (US); Sumant Jayaraman IYER, San Diego, CA (US); Kang YANG, San Diego, CA (US); Shrenik PATEL, San Diego, CA (US); Raghu Narayan CHALLA, San Diego, CA (US)

(21) Appl. No.: 18/452,501

(22) Filed: Aug. 18, 2023

(51) Int. Cl. H04W 72/542; H04W 72/0446; H04W 72/12

(52) U.S. Cl. CPC H04W 72/542; H04W 72/0446; H04W 72/12

(57) ABSTRACT

Scheduling with split symbols for beam management is described. An apparatus is configured to receive, from a network node, DL signaling including a symbol in a first slot, and to measure a first measurement of a first beam during a first time portion, and a second measurement of a second beam during a second different time portion, of the symbol. The apparatus is configured to communicate, with the network node, using the first or second beam based on at least one of the first measurement or the second measurement. Another apparatus is configured to provide, for a UE, DL signaling including a symbol in a first slot, and to communicate, with the UE, using the first or second beam based on a first and/or second measurement. The first and second measurements are of first and second beams during a first and second different time portions of the symbol, respectively.

### TECHNICAL FIELD

The present disclosure relates generally to communication systems, and more particularly, to wireless communications utilizing beam management.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus is configured to receive, from a network node, DL signaling that includes a symbol in a first slot of the DL signaling. The apparatus is also configured to measure a first measurement of a first beam at the UE during a first time portion of the symbol and a second measurement of a second beam at the UE during a second time portion of the symbol that is different from the first time portion. The apparatus is also configured to communicate, with the network node, using the first beam or the second beam based on at least one of the first measurement or the second measurement.

In the aspect, the method includes receiving, from a network node, DL signaling that includes a symbol in a first slot of the DL signaling. The method also includes measuring a first measurement of a first beam at the UE during a first time portion of the symbol and a second measurement of a second beam at the UE during a second time portion of the symbol that is different from the first time portion. The method also includes communicating, with the network node, using the first beam or the second beam based on at least one of the first measurement or the second measurement.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of beam scheduling using one beam per symbol for SSBs.

FIG. 5 is a call flow diagram for wireless communications, in accordance with various aspects of the present disclosure.

FIG. 6 is a diagram illustrating an example of beam scheduling using two beams for a split symbol of an SSB, in accordance with various aspects of the present disclosure.

FIG. 7 is a diagram illustrating an example of beam scheduling using two beams for a split symbol of an SSB, in accordance with various aspects of the present disclosure.

FIG. 8 is a flowchart of a method of wireless communication, in accordance with various aspects of the present disclosure.

FIG. 9 is a flowchart of a method of wireless communication, in accordance with various aspects of the present disclosure.

FIG. 10 is a flowchart of a method of wireless communication, in accordance with various aspects of the present disclosure.

FIG. 11 is a diagram illustrating an example of a hardware implementation for an example apparatus and/or network entity.

FIG. 12 is a diagram illustrating an example of a hardware implementation for an example network entity.

### DETAILED DESCRIPTION

Wireless communication networks, such as a 5G NR network, among other examples of wireless communication networks, may be designed to support beam management for communications between a network node (e.g., a base station, gNB, etc.) and a UE. In some examples, a UE may measure a single beam for each symbol, e.g., using a physical broadcast channel (PBCH) demodulation reference signal (DMRS) received in the symbol. If a PBCH is transmitted in two of the three symbols in a synchronization signal block (SSB), with a secondary synchronization signal (SSS) therebetween (e.g., PBCH, SSS, PBCH), or a burst set thereof, the UE may measure three beams on the three symbols of the SSB. In some aspects, a one-shot beam management (OSBM) and channel impulse response (CIR) based dynamic beam (DYB) may utilize estimates of channel correlation R matrices to manage beams.

However, such solutions may be less efficient for latency and/or for accuracy. That is, the single beam per symbol approach utilizes multiple SSBs to measure beams for a five-element antenna module, and using two SSBs for estimations of an R matrix for such an antenna module may have estimates that may be impacted due to channel changes associated with fading and/or UE mobility over the length of time for multiple SSBs to be received. For example, the delay for measurements over a second SSB may be vulnerable to a fading channel or may be affected by UE mobility, and the correlation for an R matrix may be estimated with degradation. The degradation in the estimation can impact the performance in beam tracking.

Various aspects relate generally to wireless communications systems that utilize beam management. Some aspects more specifically relate to scheduling with a split symbol for beam management. In one example, a UE may be configured to receive, from a network node, DL signaling that includes a symbol in a first slot of the DL signaling. The UE may be configured to measure a first measurement of a first beam at the UE during a first time portion of the symbol and a second measurement of a second beam at the UE during a second time portion of the symbol that is different from the first time portion. The UE may also be configured to communicate, with the network node, using the first beam or the second beam based on at least one of the first measurement or the second measurement.

Particular aspects of the subject matter described in this disclosure can be implemented to realize one or more of the following potential advantages. In one example, by splitting the measured symbols into two halves or portions, where each part may be used to measure one beam, the described techniques can be used to enable the measurement of up to six beams per SSB, e.g., based on reception of a single SSB. In another example, by measuring up to six beams per SSB, beam management speeds can be increased, leading to a reduction in latency and associated impacts. For example, the reduced latency for beam measurements can help to mitigate measurement or estimation inaccuracies due to rotation, fading, and/or mobility for a UE. Thus, improvements for utilization of OSBM and DYB implementations may be achieved by estimating the reference signal received power (RSRP) of all static beams to generate a DYB with improved accuracy within a single SSB.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

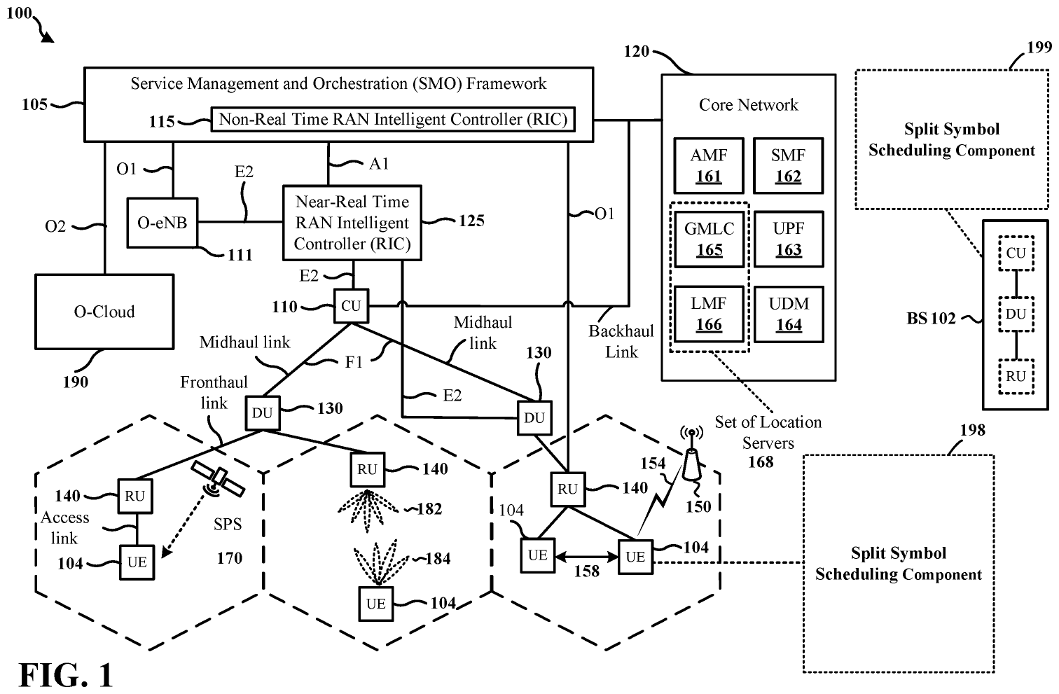

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an AI interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as AI policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FRI characteristics and/or FR2characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHZ), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2. FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a split symbol scheduling component 198 (“component 198”) that may be configured to receive, from a network node, DL signaling that includes a symbol in a first slot of the DL signaling. The component 198 may also be configured to measure a first measurement of a first beam at the UE during a first time portion of the symbol and a second measurement of a second beam at the UE during a second time portion of the symbol that is different from the first time portion. The component 198 may also be configured to communicate, with the network node, using the first beam or the second beam based on at least one of the first measurement or the second measurement. The component 198 may be configured to estimate a RSRP for at least one of the first beam based on the first measurement or the second beam based on the second measurement. The component 198 may be configured to communicate using a beam selected from the first beam or the second beam based on the estimated RSRP. The component 198 may be configured to switch from the first beam to the second beam prior to an end of the second time portion associated with the symbol. The component 198 may be configured to perform up to six measurements for up to six beams during a single SSB comprising three symbols that include a PBCH.

In certain aspects, the base station 102 may have a split symbol scheduling component 199 (“component 199”) that may be configured to operate in a commensurate manner with the component 198. The component 199 may be configured to provide or transmit, for a UE, DL signaling that includes a symbol in a first slot of the DL signaling. The component 199 may also be configured to communicate, with the UE, using a first beam or a second beam based on at least one of a first measurement or a second measurement, where the first measurement is of the first beam measured at the UE during a first time portion of the symbol and where the second measurement is of the second beam measured at the UE during a second time portion of the symbol that is different from the first time portion.

Accordingly, aspects herein for scheduling with a split symbol for beam management enable the measurement of more than three beams per SSB by using portions of a symbol to measure the SSB for a beam. As an example, the aspects may enable the measurement of six beams per SSB by splitting the measured symbols into two halves or portions, where each part may be used to measure a different beam. Additionally, beam management may be performed more quickly, and latency and associated impacts are reduced, for beam measurements by measuring up to six beams per SSB to mitigate cases of rotation, fading, and/or mobility for a UE. Thus, improvements for utilization of OSBM and DYB implementations may be achieved by estimating the RSRP of all static beams to generate a DYB with improved accuracy within a single SSB.

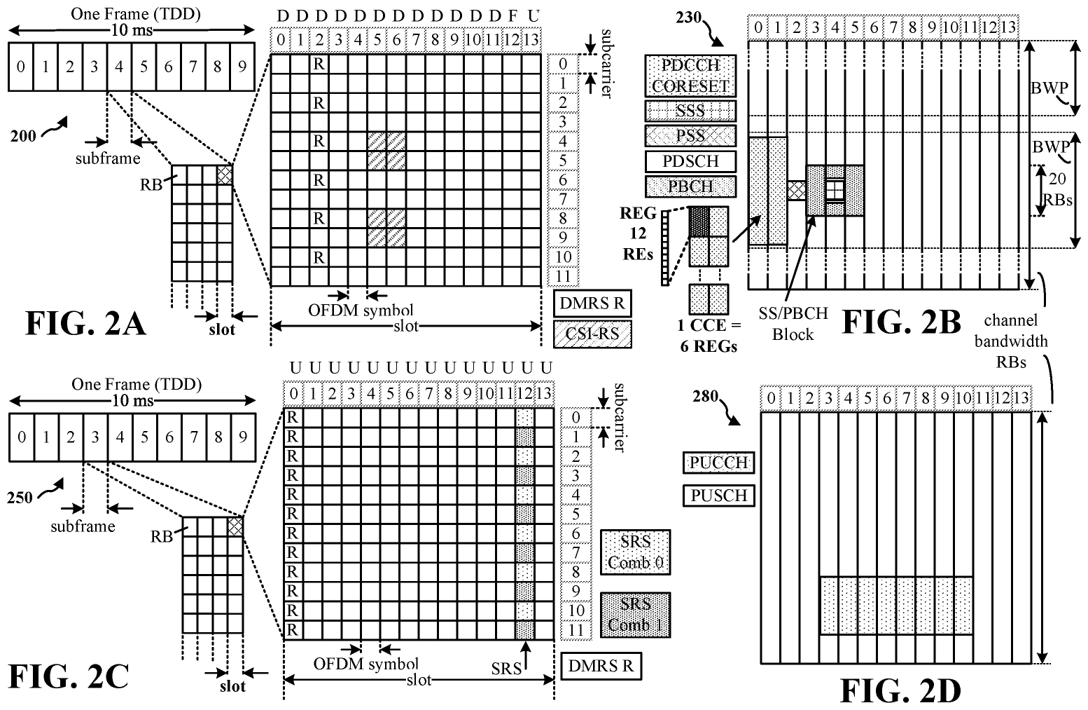

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A. 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | Cyclic |
|---|---|---|
| μ | Δf = 2^{μ} · 15 [kHz] | prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies u 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 24*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), cach CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A SSS may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages. As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

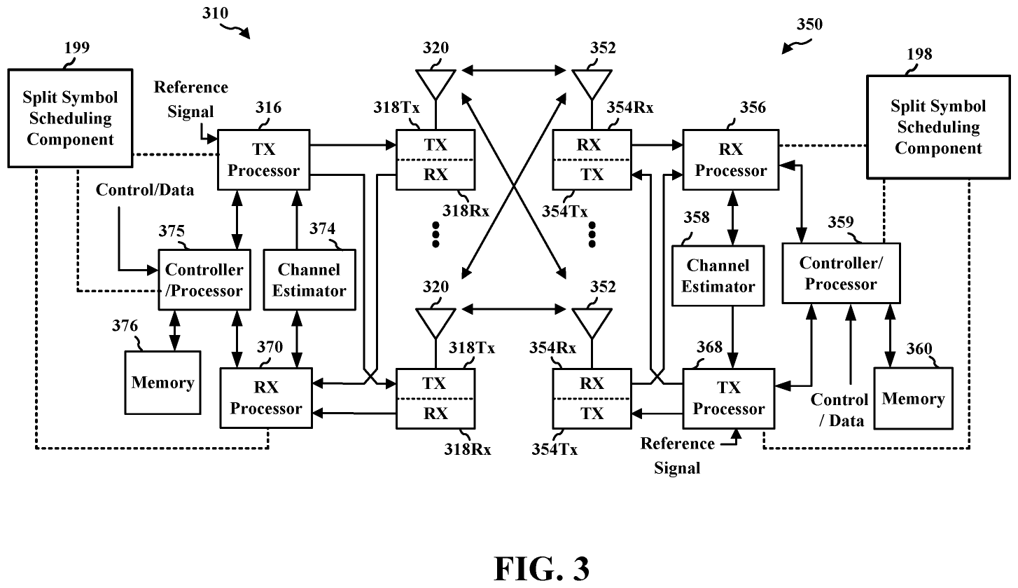

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ. priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the component 198 of FIG. 1. At least one of the TX processor 316, the RX processor 370, and the controller/processor 375 may be configured to perform aspects in connection with the component 199 of FIG. 1.

In wireless communication networks, beam management may improve communications between a network node (e.g., a base station, gNB, etc.) and a UE. In some examples, a UE may measure a single beam for cach symbol, e.g., using PBCH DMRS/SSS received in the symbols. If a PBCH is transmitted in two of the three symbols in a SSB, with an SSS therebetween (e.g., PBCH, SSS, PBCH), or a burst set thereof, the UE may measure three beams on the three symbols of the SSB. In some aspects, a OSBM and CIR based DYB may utilize estimates of channel correlation R matrices to manage beams. However, such solutions may be less efficient for latency and/or for accuracy. That is, the single beam per symbol approach utilizes multiple SSBs to measure beams for a five-element antenna module, and using two SSBs for estimations of an R matrix for such an antenna module may have estimates that may be impacted due to channel changes associated with fading and/or UE mobility over the length of time for multiple SSBs to be received. For example, the delay for measurements over a second SSB may be vulnerable to a fading channel or may be affected by UE mobility, and the correlation for an R matrix may be estimated with degradation. The degradation in the estimation can impact the performance in beam tracking.

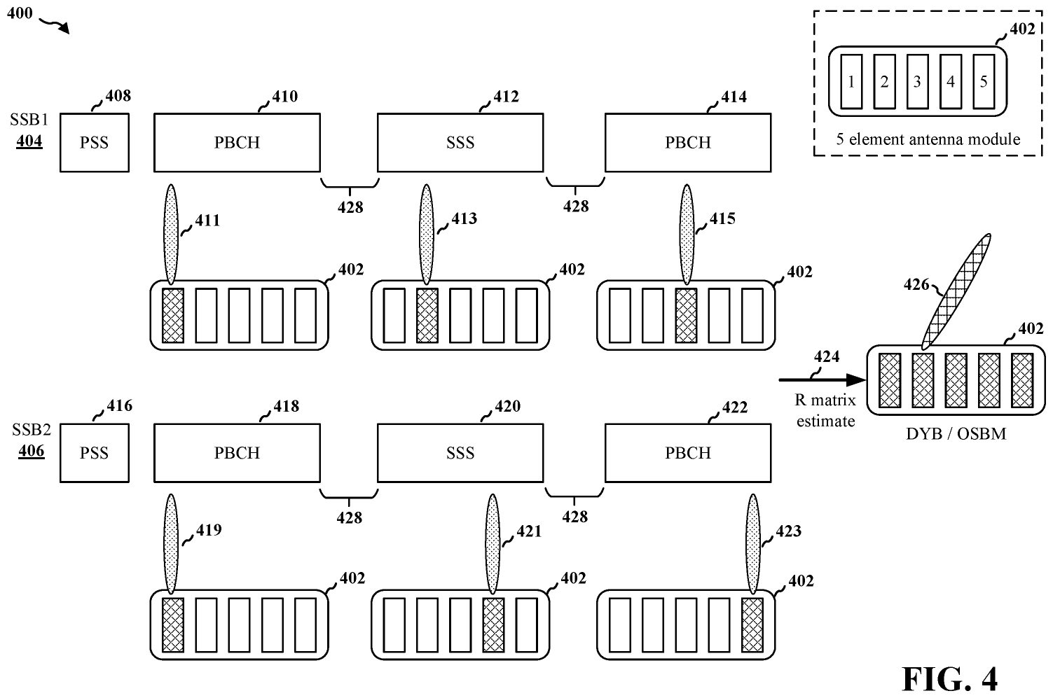

FIG. 4 is a diagram 400 illustrating an example of beam scheduling to measure one beam per symbol of a set of SSBs. Diagram 400 shows an antenna module 402 that includes five antenna elements: element 1, element 2, element 3, element 4, and element 5. The antenna module 402 may be configured to measure beams for each of the elements over two SSBs: an SSB1 404 and an SSB2 406.

As shown, SSB1 404 may include a symbol including a primary synchronization signal (PSS) 408, a first PBCH symbol 410, a symbol including a SSS 412, and a second PBCH symbol 414, each representing a single symbol. FIG. 2B illustrates an example SSB. SSB2 406 may include a symbol with a PSS 416, a first PBCH symbol 418, a symbol including a SSS 420, and a second PBCH symbol 422, cach representing a single symbol. During a time for the first PBCH symbol 410, element 1 of the antenna module 402 may be utilized to measure a beam 411 by using the antenna element to receive and measure the first PBCH symbol 410 (e.g., performing a measurement on the PBCH DMRS received from the network node in the first PBCH symbol of the SSB). During a time for the SSS 412, element 2 of the antenna module 402 may be utilized to measure a beam 413 with respect to the symbol for the SSS 412 (e.g., using the antenna element 2 to perform a measurement on the PBCH DMRS received in the SSS symbol of the SSB). During a time for the second PBCH symbol 414, element 3 of the antenna module 402 may be utilized to measure a beam 415 with respect to the symbol for the second PBCH symbol 414 (e.g., using the antenna element 3 to perform a measurement on the PBCH DMRS received in the second PBCH symbol of the SSB). For each symbol of the first PBCH symbol 410, the SSS 412, and the second PBCH symbol 414, a single beam is measured for a single element of the antenna array in the antenna module 402.

As shown, SSB2 406 may include a PSS 416, a first PBCH symbol 418, a SSS 420, and a second PBCH symbol 422, each representing a single symbol. During a time for the first PBCH symbol 418, element 1 of the antenna module 402 may be utilized to measure a beam 419 with respect to the symbol for the first PBCH symbol 418. During a time for the SSS 420, element 4 of the antenna module 402 may be utilized to measure a beam 421 with respect to the symbol for the SSS 420.

During a time for the second PBCH symbol 422, element 5 of the antenna module 402 may be utilized to measure a beam 423 with respect to the symbol for the second PBCH symbol 422. For each symbol of the first PBCH symbol 418, the SSS 420, and the second PBCH symbol 422, a single beam is measured for a single element of the antenna array in antenna module 402, where beam switching occasions 428 are present for the antenna module 402 between, but not during, symbols.

An R matrix estimate 424 may be calculated/determined by a device, e.g., a UE, of which the antenna module 402 is a part. The R matrix estimate 424 may be utilized for OSBM and/or CIR-based DYB to determine, and perform beam management for, a beam 426. The beam 426 may be used to communicate with a base station, gNB, and/or the like. As shown, a single beam may be measured per symbol, and in order to calculate/determine the R matrix estimate 424, two SSBs are utilized. The additional delay introduced for the latter SSB (e.g., the SSB2 406) may make the R matrix estimate 424 susceptible channel changes due to rotation, fading, and/or mobility of the device, which may degrade performance.

For the aspects herein, splitting a symbol in multiple portions (e.g., two halves) in the time domain allows the measurement of multiple different beams during the same SSB symbols. Aspects herein provide for a UE to schedule a split symbol measurement for beam management to enable the measurement of more than three beams per SSB by splitting the measured symbols into two halves or multiple portions, where each part of the SSB symbol may be used to measure a different beam. Additionally, beam management measurements and decisions may be performed more quickly, and latency and associated impacts may be reduced, for beam measurements by measuring up to six beams per SSB to mitigate cases of rotation, fading, and/or mobility for a UE. Thus, improvements for utilization of OSBM and DYB implementations may be achieved by estimating the RSRP of all static beams to generate a DYB with improved accuracy within a single SSB.

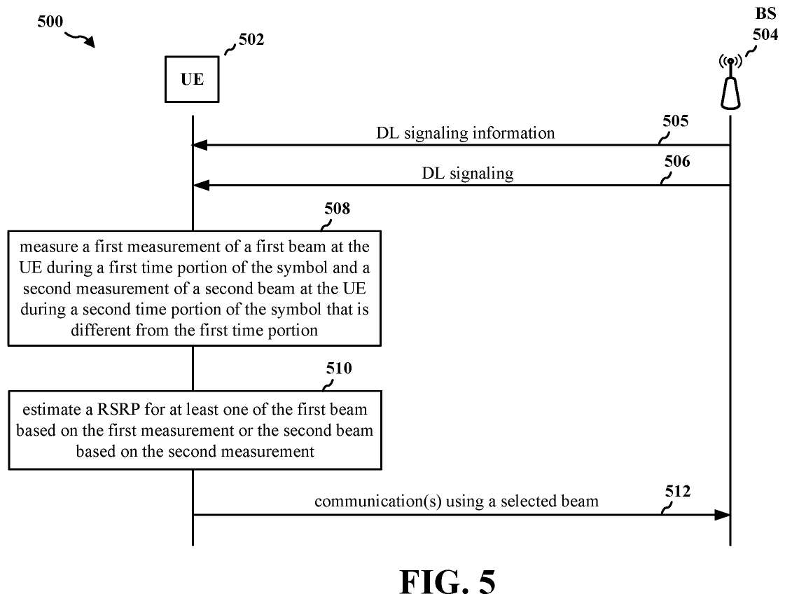

FIG. 5 is a call flow diagram 500 for wireless communications, in various aspects. Call flow diagram 500 illustrates scheduling with a split symbol for beam management at a wireless device (a UE 502, by way of example) that communicates with the network node (a base station 504, such as a gNB or other type of base station, by way of example, as shown), in various aspects. Aspects described for the base station 504 may be performed by the base station in aggregated form and/or by one or more components of the base station in disaggregated form. Additionally, or alternatively, the aspects may be performed by the UE 502 autonomously, in addition to, and/or in lieu of, operations of the base station 504. The UE 502 may be configured to with an antenna module (not shown, but included for FIGS. described below) that may include a plurality of antenna elements (e.g., 5 antennas, or another number of antennas, of an antenna module/array).

In the illustrated aspect, the UE 502 may be configured to receive DL signaling 506, which the base station 504 may be configured to transmit/provide. For example, the base station 504 may configure a reference signal for the UE to measure. As an example, the base station 504 may provide an indication of times when an SSB will be transmitted and/or times for the UE to perform measurements of the SSB. FIG. 5 illustrates the base station 504 transmitting information about the reference signal to the UE 502, at 505. The DL signaling 506 may include a DL signal during one or more symbols. In aspects, the DL signaling may include one or more symbols in a slot of the DL signaling 506, and in aspects, may include symbols of an SSB (e.g., a PSS symbol, a first PBCH symbol, a SSS symbol, and a second PBCH symbol, e.g., as described in connection with FIG. 2B). The PBCH may include DMRS, e.g., as a reference signal to be measured by the UE 502. In some aspects, the base station may transmit the first PBCH during a first symbol, the SSS during a second symbol, and the second PBCH during a third symbol. That is, the DL signaling 506 may comprise a SSB that includes a first symbol comprising a PBCH, a second symbol comprising a SSS and the PBCH, and a third symbol that includes the PBCH. In aspects, the DL signaling 506 may correspond to the first symbol, the second symbol, or the third symbol of the SSB.

The UE 502 may be configured to measure (at 508) a first measurement for a first beam at the UE 502 during a first time portion of a symbol of the DL signaling (e.g., SSB) and a second measurement of a second beam at the UE 502 during a second time portion of the symbol of the DL signaling, the second portion of the symbol being different from the first time portion. In other words, the UE 502 may be configured to perform measurements (at 508) for multiple (e.g., two) beams during a single symbol of the DL signaling (e.g., SSB). Accordingly, if the UE uses a first half of the symbol to measure a first beam and a second half of the symbol to measure a second beam, the UE 502 may be configured to perform up to six measurements for up to six beams during a single SSB comprising three symbols that include a physical broadcast channel PBCH. In aspects for which up to six beams may be measured, the UE may measure a separate measurement for each of the up to six beams. The beams measured (at 508) may respectively correspond to antenna elements of an antenna module/array of the UE 502.

Further, the UE 502 may be configured to switch beams during a symbol, e.g., split symbol scheduling) to perform multiple beam measurements during the symbol, e.g., at different times within the symbol. For example, a first beam may be active for measurement over a first part of the symbol that corresponds to the first time portion, and the second beam may be active over a different second part of the symbol that corresponds to the second time portion. The UE 502 may be configured to switch from the first beam to the second beam prior to an end of the second time portion associated with the symbol.

Additionally, the UE 502 may be configured to measure a third beam and a fourth beam during a second symbol, and/or to measure at least a fifth beam during a third symbol. Correspondingly, the UE 502 may be configured to perform the switch from the third beam to the fourth beam during the second symbol. In aspects, a beam switching rate utilized by the UE 502 for scheduling with a split symbol for beam management may be double the SCS for the DL signaling 506. As one example, if the DL signaling 506 has a SCS of, or approximately, 120 kHz, the UE 502 may be configured to switch from one beam to another beam for a single symbol using a beam switch rate at a SCS of, or approximately, 240 kHz (e.g., at approximately double the signaling SCS).

The UE 502 may be configured to estimate (at 510) an RSRP for at least one of the first beam based on the first measurement or the second beam based on the second measurement. In aspects for which up to six beams may be measured, a separate estimate (at 510) one or more of the up to six beams may be made for each beam measured. The UE 502 may be configured to utilize an R matrix estimate for the estimate (at 510). An R matrix estimate may be utilized for OSBM and/or CIR-based DYB (by way of example and not limitation) to determine, and perform beam management for a beam that is used by the UE 502 for communications with the base station 504. An R matrix estimate may be performed within a single SSB to support faster performance for the UE 502 with up to six antenna elements in an antenna module.

The UE 502 may be configured to communicate, with the network node (and vice versa), using the first beam or the second beam based on at least one of the first measurement or the second measurement. That is, in aspects, the UE 502 may be configured to provide/transmit communication(s) 512 to, and/or receive from, the base station 504 using a selected beam based on the beam measurements (e.g., at 508) and/or the estimation(s) (e.g., at 510).

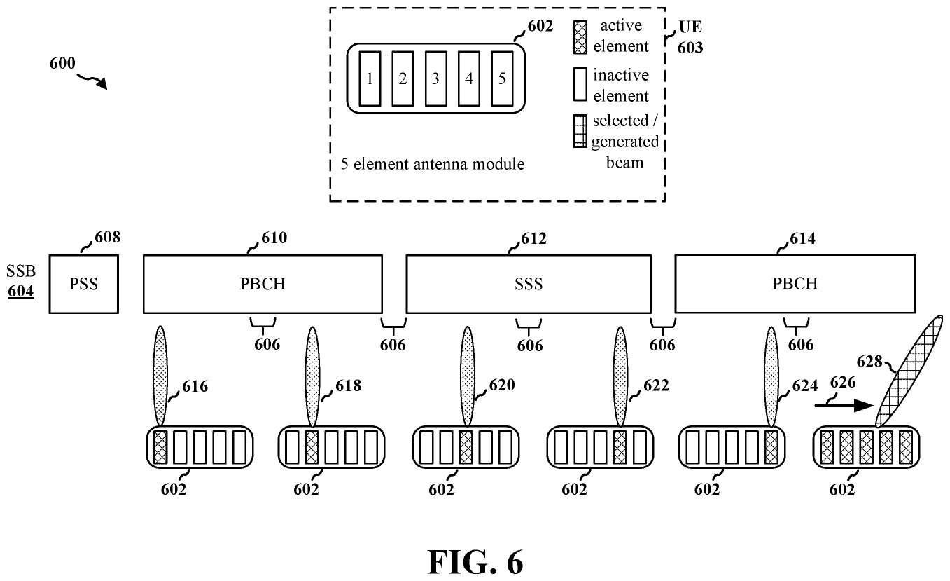

FIG. 6 is a diagram 600 illustrating an example of beam scheduling for multiple beam measurements within portions of the symbols of an SSB. For example, the diagram 600 shows scheduling for measurement of two beams using a split symbol of an SSB. The beam measurements and estimations in connection with diagram 600 may include aspects of beam measurement and estimation described in connection with the diagram 500 in FIG. 5. Diagram 600 shows multi-element antenna module 602 (“antenna module 602”), of a UE 603, having five antenna elements, by way of example: element 1, element 2, element 3, element 4, and element 5.

As described above, aspects herein enable the measurement of two (or more) beams during a single symbol, e.g., enabling the measurement of more than three beams using a single SSB. The illustrated aspects show an SSB 604 having a PSS 608, a first PBCH 610, a SSS 612, and a second PBCH 614, which may each represent a single symbol of the SSB 604. That is, the UE 603 and/or the antenna module 602 may be configured to measure a first measurement of a first beam at the UE 603 during a first time portion of a symbol and a second measurement of a second beam at the UE 603 during a second time portion of the symbol that is different from the first time portion. For example, the UE may use a beam to measure the DMRS in the PBCH during the portion of the SSB symbol in order to obtain the corresponding beam measurement. Aspects herein provide for switching occasions 606 between symbols (e.g., between the first PBCH 610 and the SSS 612, and between the SSS 612 and the second PBCH 614), as well as during the symbols for the first PBCH 610, the SSS 612, and the second PBCH 614, which enables two beam measurements for a single symbol. For instance, the UE 603, and/or the antenna module 602, may be configured to measure the PBCH DMRS, during a first time portion of the first PBCH 610, e.g., using element 1 of the antenna module 602, to obtain a beam measurement for a beam 616. The UE 603, and/or the antenna module 602, may also be configured to measure the PBCH DMRS during a second time portion of the first PBCH 610, e.g., using element 2 of the antenna module 602, e.g., after an switching occasion 606 during the symbol for the first PBCH 610, to obtain a measurement for a beam 618. Between the first PBCH 610 and the SSS 612, another switching occasions 606 allows for a switch from the beam 618 to a beam 620.

Thus, the UE 603, and/or the antenna module 602, may be configured to measure a PBCH DMRS, during a first time portion of the SSS 612, e.g., using element 3 of the antenna module 602, to obtain a measurement for the beam 620. The UE 603, and/or the antenna module 602, may also be configured to measure the PBCH DMRS, during a second time portion of the SSS 612, e.g., using element 4 of the antenna module 602, after a switching occasions 606 during the symbol for the SSS 612, to obtain a beam measurement for a beam 622. Between the SSS 612 and second PBCH 614, a switching occasion 606 allows for a switch from the beam 622 to a beam 624.

Similarly, the UE 603 and/or the antenna module 602 may be configured to measure, during a first time portion of the second PBCH 614, and with respect to element 5 of the antenna module 602, the beam 624 associated with the symbol for the second PBCH 614.

In one configuration, the UE 603 and/or the antenna module 602 may be configured to measure again, during a second time portion of the second PBCH 614, e.g., based on an occasion of the switching occasions 606 during the symbol for the second PBCH 614, one of the beam 616, the beam 618, the beam 620, the beam 622, or the beam 624, or to measure a different beam (e.g., such as for a six-element antenna module), for a second time portion associated with the symbol for the second PBCH 614.

In another configuration, the UE 603 may be configured to determine/select a beam 628 for communications with a network node associated with the SSB 604 (e.g., a base station, gNB, etc., from which the SSB 604 was provided/transmitted). In aspects, the beam 628 may be based on the measurements described above for at least one of the beam 616, the beam 618, the beam 620, the beam 622, and/or the beam 624 made over the symbols for the SSB 604. An R matrix estimate 626 may be calculated/determined by the UE 603.

The R matrix estimate 626 may be utilized for OSBM and/or CIR-based DYB (by way of example and not limitation) to determine, and perform beam management for, the beam 628. The R matrix estimate 626 may be performed within a single SSB, e.g., the SSB 604, and thus, aspects herein may support this faster performance for a device (e.g., the UE 603) with up to six antenna elements in an antenna module (e.g., the antenna module 602).

Through OSBM, by way of example, the RSRP for each of the beams of an antenna module may be predicted using the R matrix estimate 626. Additionally, aspects provide for generating dynamic beams with optimal RSRP using a computation of the eigenvector of the R matrix estimate 626. Because all the measurement of R matrix can be finished in a single SSB, the described aspects provide efficient beam tracking, which produces large improvements/gains in rotation or fading cases for a wireless device.

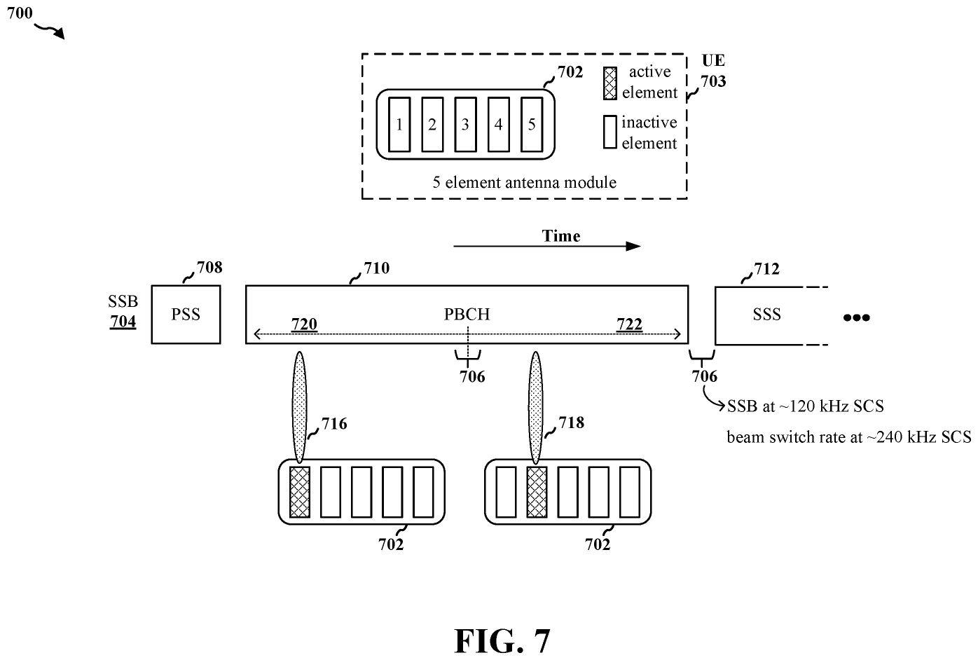

FIG. 7 is a diagram 700 illustrating an example of beam scheduling using two beams for a split symbol of an SSB, in various aspects. Diagram 700 may be a further aspect of diagram 500 in FIG. 5 and/or diagram 600 in FIG. 6. Diagram 700 shows multi-element antenna module 702 (“antenna module 702”), of a UE 703, having five antenna elements, by way of example: element 1, element 2, element 3, element 4, and element 5.

As described herein, aspects enable the measurement of two beams for a single symbol. The illustrated aspect shows an SSB 704 having a PSS 708, a first PBCH 710, a SSS 712, and a second PBCH (not shown for brevity), which may each represent a single symbol of the SSB 704. That is, the UE 703 and/or the antenna module 702 may be configured to measure a first measurement of a first beam at the UE 703 during a first time portion of a symbol and a second measurement of a second beam at the UE 703 during a second time portion of the symbol that is different from the first time portion.

Aspects herein provide for switching occasions 706 between symbols (e.g., between the first PBCH 710 and the SSS 612), as well as during the symbols (e.g., as shown for the first PBCH 710), which enables two beam measurements for single symbol. For instance, the UE 703 and/or the antenna module 702 may be configured to measure, during a first time portion 720 of the first PBCH 710, and with respect to element 1 of the antenna module 702, a beam 716 associated with the symbol for the first PBCH 710. The UE 703 and/or the antenna module 702 may also be configured to measure during a second time portion 722 of the first PBCH 710, and with respect to element 2 of the antenna module 702, e.g., based on an occasion of the switching occasions 706 during the symbol for the first PBCH 710, a beam 718 associated with the symbol for the first PBCH 710.

In aspects, occasions of the switching occasions 706 that occur during a symbol (e.g., as shown for the first PBCH 710) may be at or approximately at midway of a duration of the symbol. That is, by way of example and not limitation, the symbol splitting measurements herein may be based on a first half and a second half of the symbol. In other aspects, an occasion of the switching occasions 706 that occurs during a symbol may take place at any other location of the symbol. That is, the first time portion 720 of the first PBCH 710 and the second time portion 722 of the first PBCH 710 may be equal or unequal in duration.

In some aspects, a switch from a first beam to a second beam may be made at a switching occasion prior to an end of a second time portion associated with a symbol. For instance, a switch from the beam 716 to the beam 718 may be made at a switching occasion of the switching occasions 706 prior to an end of the second time portion 722 associated with the symbol for the first PBCH 710.

In various configurations, the beam switch rate by which a beam switch is performed at a switching occasion of the switching occasions 706 may be at least double, or approximately double, of the SCS for the symbol(s) on which beam measurement(s) is/are performed. As one example, where the SSB 704 has a ˜120 kHz SCS, the beam switch rate utilized by the UE 703 for switching from the beam 716 (for element 1 of the antenna module 702) to the beam 718 (for element 2 of the antenna module 702) may be at a ˜240 KHz SCS.

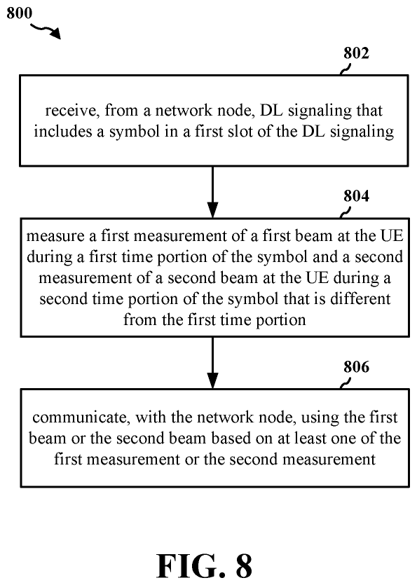

FIG. 8 is a flowchart 800 of a method of wireless communication, in various aspects. The method may be performed by a UE (e.g., the UE 104, 502, 603, 703; the apparatus 1104). In some aspects, the method may include aspects described in connection with the communication flow in FIG. 5 and/or aspects described in FIGS. 6, 7. The method may be for scheduling with a split symbol for beam management and enables the measurement of up to six beams per SSB by splitting the measured symbols into two halves or portions, where each part may be used to measure one beam, and enables speed increases, and reductions of latency and associated impacts, for beam measurements to mitigate cases of rotation, fading, and/or mobility for a UE by measuring up to six beams per SSB.

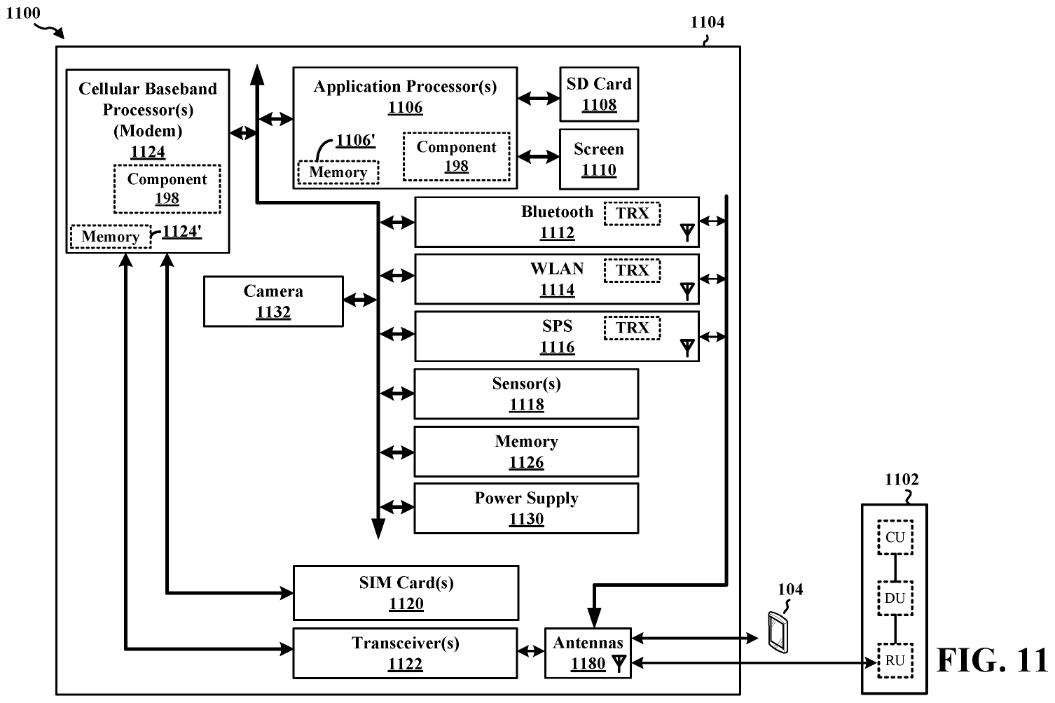

At 802, the UE receives, from a network node, DL signaling that includes a symbol in a first slot of the DL signaling. As an example, the reception may be performed by one or more of the component 198, the transceiver 1122, and/or the antenna 1180 in FIG. 11. FIGS. 5-7 illustrates an example of the UE 502 receiving such DL signaling from a network node (e.g., the base station 504).

The UE 502 may be configured to receive DL signaling 506, which the base station 504 may be configured to transmit/provide. The DL signaling 506 may include a symbol. In aspects, the DL signaling may include one or more symbols in a slot of the DL signaling 506, and in aspects, may include symbols of an SSB (e.g., 604 in FIG. 6; 704 in FIG. 7) (e.g., a PSS, a first PBCH (e.g., 610 in FIG. 6; 710 in FIG. 7), a SSS (e.g., 612 in FIG. 6; 712 in FIG. 7), and a second PBCH (e.g., 614 in FIG. 6)). In some aspects, the first PBCH (e.g., 610 in FIG. 6; 710 in FIG. 7) may correspond to a first symbol, the SSS (e.g., 612 in FIG. 6; 712 in FIG. 7) may correspond to a second symbol, and the second PBCH may correspond to a third symbol. That is, the DL signaling 506 may comprise a SSB (e.g., 604 in FIG. 6; 704 in FIG. 7) that includes a first symbol comprising a PBCH (e.g., 610 in FIG. 6; 710 in FIG. 7), a second symbol comprising a SSS (e.g., 612 in FIG. 6; 712 in FIG. 7) and the PBCH, and a third symbol that includes the PBCH (e.g., 614 in FIG. 6). In aspects, the symbol received using the DL signaling 506 may correspond to the first symbol, the second symbol, or the third symbol of the SSB (e.g., 604 in FIG. 6; 704 in FIG. 7).

At 804, the UE measures a first measurement of a first beam (e.g., 616, 620, 624 in FIG. 6; 716 in FIG. 7) at the UE during a first time portion of the symbol and a second measurement of a second beam (e.g., 618, 622 in FIG. 6; 718 in FIG. 7) at the UE during a second time portion of the symbol that is different from the first time portion. As an example, the measurement may be performed by one or more of the component 198, the transceiver 1122, and/or the antenna 1180 in FIG. 11. FIGS. 5-7 illustrates an example of the UE 502 measuring such beams for symbols in DL signaling from a network node (e.g., the base station 504).

The UE 502 may be configured to measure (at 508) a first measurement of a first beam (e.g., 616, 620, 624 in FIG. 6; 716 in FIG. 7) at the UE 502 during a first time portion (e.g., 720 in FIG. 7) of the symbol and a second measurement of a second beam (e.g., 618, 622 in FIG. 6; 718 in FIG. 7) at the UE 502 during a second time portion (e.g., 722 in FIG. 7) of the symbol that is different from the first time portion (e.g., 720 in FIG. 7). In other words, the UE 502 may be configured to measure (at 508) two beams utilizing a single symbol. Accordingly, the UE 502 may be configured to perform up to six measurements for up to six beams (e.g., 616, 618, 620, 622, 624 in FIG. 6) during a single SSB (e.g., 604 in FIG. 6; 704 in FIG. 7) comprising three symbols that include a PBCH. In aspects for which up to six beams (e.g., 616, 618, 620, 622, 624 in FIG. 6) may be measured, a separate measurement for each of the up to six beams (e.g., 616, 618, 620, 622, 624 in FIG. 6) may be made. The beams measured (at 508) may respectively correspond to antenna elements of an antenna module/array (e.g., 602 in FIG. 6; 702 in FIG. 7) of the UE 502.

Further, the UE 502 may be configured to switch (e.g., 606 in FIG. 6; 706 in FIG. 7) beams during a symbol, e.g., split symbol scheduling). For example, a first beam (e.g., 616, 620, 624 in FIG. 6; 716 in FIG. 7) may be active for measurement over a first part of the symbol that corresponds to the first time portion (e.g., 720 in FIG. 7), and the second beam (e.g., 618, 622 in FIG. 6; 718 in FIG. 7) may be active over a different second part of the symbol that corresponds to the second time portion (e.g., 722 in FIG. 7). The UE 502 may be configured to switch (e.g., 606 in FIG. 6; 706 in FIG. 7) from the first beam (e.g., 616, 620, 624 in FIG. 6; 716 in FIG. 7) to the second beam (e.g., 618, 622 in FIG. 6; 718 in FIG. 7) prior to an end of the second time portion (e.g., 722 in FIG. 7) associated with the symbol.

Additionally, the UE 502 may be configured to measure a third beam and a fourth beam (e.g., 620, 622 in FIG. 6) during a second symbol (e.g., 612 in FIG. 6), and/or to measure at least a fifth beam (e.g., 624 in FIG. 6) during a third symbol (e.g., 614 in FIG. 6). Correspondingly, the UE 502 may be configured to perform the switch (e.g., 606 in FIG. 6; 706 in FIG. 7) from the third beam to the fourth beam during the second symbol. In aspects, a beam switching rate utilized by the UE 502 for scheduling with a split symbol for beam management may be double the SCS for the DL signaling 506. As one example, if the DL signaling 506 has a SCS of, or approximately, 120 kHz, the UE 502 may be configured to switch (e.g., 606 in FIG. 6; 706 in FIG. 7) from one beam to another beam for a single symbol using a beam switch rate at a SCS of, or approximately, 240 kHz (e.g., at approximately double the signaling SCS).

The UE 502 may be configured to estimate (at 510) a RSRP for at least one of the first beam (e.g., 616, 620, 624 in FIG. 6; 716 in FIG. 7) based on the first measurement or the second beam (e.g., 618, 622 in FIG. 6; 718 in FIG. 7) based on the second measurement. In aspects for which up to six beams (e.g., 616, 618, 620, 622, 624 in FIG. 6) may be measured, a separate estimate (at 510) one or more of the up to six beams (e.g., 616, 618, 620, 622, 624 in FIG. 6) may be made for each beam measured. The UE 502 may be configured to utilize an R matrix estimate (e.g., 626 in FIG. 6) for the estimate (at 510). An R matrix estimate (e.g., 626 in FIG. 6) may be utilized for OSBM and/or CIR-based DYB (by way of example and not limitation) to determine, and perform beam management for a beam (e.g., 628) that is used by the UE 502 for communications with the base station 504. An R matrix estimate (e.g., 626 in FIG. 6) may be performed within a single SSB (e.g., 604 in FIG. 6; 704 in FIG. 7) to support faster performance for the UE 502 with up to six antenna elements in an antenna module (e.g., 602 in FIG. 6; 702 in FIG. 7).

At 806, the UE communicates, with the network node, using the first beam or the second beam based on at least one of the first measurement or the second measurement. As an example, the communication may be performed, at least in part, by one or more of the component 198, the transceiver 1122, and/or the antenna 1180 in FIG. 11. FIGS. 5, 6 illustrate an example of the UE 502 communicating with a network node (e.g., the base station 504).

The UE 502 may be configured to communicate, with the network node (and vice versa), using the first beam or the second beam based on at least one of the first measurement or the second measurement. That is, in aspects, the UE 502 may be configured to provide/transmit communication(s) 512 to, and/or receive from, the base station 504 using a selected beam (e.g., 628 in FIG. 6) based on the beam measurements (e.g., at 508) and/or the estimation(s) (e.g., at 510).

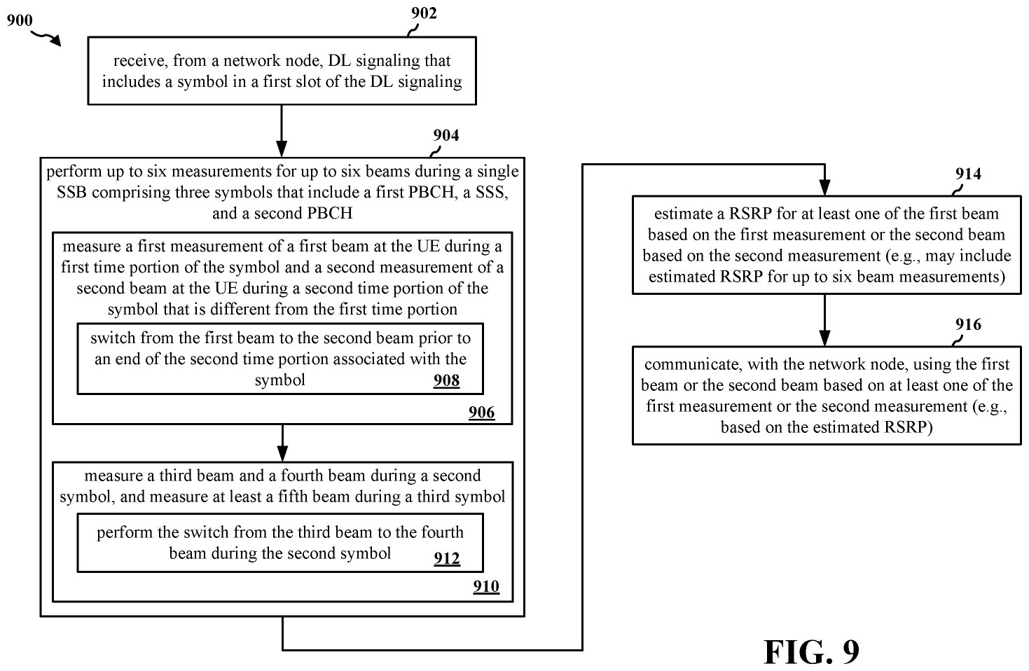

FIG. 9 is a flowchart 900 of a method of wireless communication, in various aspects. The method may be performed by a UE (e.g., the UE 104, 502, 603, 703; the apparatus 1104). In some aspects, the method may include aspects described in connection with the communication flow in FIG. 5 and/or aspects described in FIGS. 6, 7. The method may be for scheduling with a split symbol for beam management and enables the measurement of up to six beams per SSB by splitting the measured symbols into two halves or portions, where each part may be used to measure one beam, and enables speed increases, and reductions of latency and associated impacts, for beam measurements to mitigate cases of rotation, fading, and/or mobility for a UE by measuring up to six beams per SSB.

At 902, the UE receives, from a network node, DL signaling that includes a symbol in a first slot of the DL signaling. As an example, the reception may be performed by one or more of the component 198, the transceiver 1122, and/or the antenna 1180 in FIG. 11. FIGS. 5-7 illustrates an example of the UE 502 receiving such DL signaling from a network node (e.g., the base station 504).

The UE 502 may be configured to receive DL signaling 506, which the base station 504 may be configured to transmit/provide. The DL signaling 506 may include a symbol. In aspects, the DL signaling may include one or more symbols in a slot of the DL signaling 506, and in aspects, may include symbols of an SSB (e.g., 604 in FIG. 6; 704 in FIG. 7) (e.g., a PSS, a first PBCH (e.g., 610 in FIG. 6; 710 in FIG. 7), a SSS (e.g., 612 in FIG. 6; 712 in FIG. 7), and a second PBCH (e.g., 614 in FIG. 6)). In some aspects, the first PBCH (e.g., 610 in FIG. 6; 710 in FIG. 7) may correspond to a first symbol, the SSS (e.g., 612 in FIG. 6; 712 in FIG. 7) may correspond to a second symbol, and the second PBCH may correspond to a third symbol. That is, the DL signaling 506 may comprise a SSB (e.g., 604 in FIG. 6; 704 in FIG. 7) that includes a first symbol comprising a PBCH (e.g., 610 in FIG. 6; 710 in FIG. 7), a second symbol comprising a SSS (e.g., 612 in FIG. 6; 712 in FIG. 7) and the PBCH, and a third symbol that includes the PBCH (e.g., 614 in FIG. 6). In aspects, the symbol received using the DL signaling 506 may correspond to the first symbol, the second symbol, or the third symbol of the SSB (e.g., 604 in FIG. 6; 704 in FIG. 7).

At 904, the UE performs up to six measurements for up to six beams during a single SSB comprising three symbols that include a PBCH. As an example, the measurement may be performed by one or more of the component 198, the transceiver 1122, and/or the antenna 1180 in FIG. 11. FIGS. 5-7 illustrates an example of the UE 502 measuring such beams for symbols in DL signaling from a network node (e.g., the base station 504).

In aspects for which up to six beams (e.g., 616, 618, 620, 622, 624 in FIG. 6) may be measured, a separate measurement for each of the up to six beams (e.g., 616, 618, 620, 622, 624 in FIG. 6) may be made. The beams measured (at 508) may respectively correspond to antenna elements of an antenna module/array (e.g., 602 in FIG. 6; 702 in FIG. 7) of the UE 502.

For instance, at 906, the UE measures a first measurement of a first beam at the UE during a first time portion of the symbol and a second measurement of a second beam at the UE during a second time portion of the symbol that is different from the first time portion. As an example, the measurement may be performed by one or more of the component 198, the transceiver 1122, and/or the antenna 1180 in FIG. 11. FIGS. 5-7 illustrates an example of the UE 502 measuring such beams for symbols in DL signaling from a network node (e.g., the base station 504).

The UE 502 may be configured to measure (at 508) a first measurement of a first beam (e.g., 616, 620, 624 in FIG. 6; 716 in FIG. 7) at the UE 502 during a first time portion (e.g., 720 in FIG. 7) of the symbol and a second measurement of a second beam (e.g., 618, 622 in FIG. 6; 718 in FIG. 7) at the UE 502 during a second time portion (e.g., 722 in FIG. 7) of the symbol that is different from the first time portion (e.g., 720 in FIG. 7). In other words, the UE 502 may be configured to measure (at 508) two beams utilizing a single symbol. Accordingly, the UE 502 may be configured to perform up to six measurements for up to six beams (e.g., 616, 618, 620, 622, 624 in FIG. 6) during a single SSB (e.g., 604 in FIG. 6; 704 in FIG. 7) comprising three symbols that include a PBCH.

At 908, the UE switches from the first beam to the second beam prior to an end of the second time portion associated with the symbol. As an example, the switch may be performed by one or more of the component 198, the transceiver 1122, and/or the antenna 1180 in FIG. 11. FIGS. 5-7 illustrates an example of the UE 502 switching between beams to facilitate two beam measurements for a single symbol.

The UE 502 may be configured to switch (e.g., 606 in FIG. 6; 706 in FIG. 7) beams during a symbol, e.g., split symbol scheduling). For example, a first beam (e.g., 616, 620, 624 in FIG. 6; 716 in FIG. 7) may be active for measurement over a first part of the symbol that corresponds to the first time portion (e.g., 720 in FIG. 7), and the second beam (e.g., 618, 622 in FIG. 6; 718 in FIG. 7) may be active over a different second part of the symbol that corresponds to the second time portion (e.g., 722 in FIG. 7). The UE 502 may be configured to switch (e.g., 606 in FIG. 6; 706 in FIG. 7) from the first beam (e.g., 616, 620, 624 in FIG. 6; 716 in FIG. 7) to the second beam (e.g., 618, 622 in FIG. 6; 718 in FIG. 7) prior to an end of the second time portion (e.g., 722 in FIG. 7) associated with the symbol.

At 910, the UE measures a third beam and a fourth beam during a second symbol, and measure at least a fifth beam during a third symbol. As an example, the measurement may be performed by one or more of the component 198, the transceiver 1122, and/or the antenna 1180 in FIG. 11. FIGS. 5-7 illustrates an example of the UE 502 measuring such beams for symbols in DL signaling from a network node (e.g., the base station 504). At 912, the UE performs the switch from the third beam to the fourth beam during the second symbol. As an example, the reception may be performed by one or more of the component 198, the transceiver 1122, and/or the antenna 1180 in FIG. 11. FIGS. 5-7 illustrates an example of the UE 502 receiving such DL signaling from a network node (e.g., the base station 504). As an example, the switch may be performed by one or more of the component 198, the transceiver 1122, and/or the antenna 1180 in FIG. 11. FIGS. 5-7 illustrates an example of the UE 502 switching between beams to facilitate two beam measurements for a single symbol.

The UE 502 may be configured to measure a third beam and a fourth beam (e.g., 620, 622 in FIG. 6) during a second symbol (e.g., 612 in FIG. 6), and/or to measure at least a fifth beam (e.g., 624 in FIG. 6) during a third symbol (e.g., 614 in FIG. 6). Correspondingly, the UE 502 may be configured to perform the switch (e.g., 606 in FIG. 6; 706 in FIG. 7) from the third beam to the fourth beam during the second symbol. In aspects, a beam switching rate utilized by the UE 502 for scheduling with a split symbol for beam management may be double the SCS for the DL signaling 506. As one example, if the DL signaling 506 has a SCS of, or approximately, 120 kHz, the UE 502 may be configured to switch (e.g., 606 in FIG. 6; 706 in FIG. 7) from one beam to another beam for a single symbol using a beam switch rate at a SCS of, or approximately, 240 kHz (e.g., at approximately double the signaling SCS).

At 914, the UE estimates a RSRP for at least one of the first beam based on the first measurement or the second beam based on the second measurement (e.g., may include estimated RSRP for up to six beam measurements). As an example, the estimation may be performed by one or more of the component 198, the transceiver 1122, and/or the antenna 1180 in FIG. 11. FIGS. 5-7 illustrates an example of the UE 502 estimating such RSRP based on beam measurements for signaling from a network node (e.g., the base station 504).

The UE 502 may be configured to estimate (at 510) a RSRP for at least one of the first beam (e.g., 616, 620, 624 in FIG. 6; 716 in FIG. 7) based on the first measurement or the second beam (e.g., 618, 622 in FIG. 6; 718 in FIG. 7) based on the second measurement. In aspects for which up to six beams (e.g., 616, 618, 620, 622, 624 in FIG. 6) may be measured, a separate estimate (at 510) one or more of the up to six beams (e.g., 616, 618, 620, 622, 624 in FIG. 6) may be made for each beam measured. The UE 502 may be configured to utilize an R matrix estimate (e.g., 626 in FIG. 6) for the estimate (at 510). An R matrix estimate (e.g., 626 in FIG. 6) may be utilized for OSBM and/or CIR-based DYB (by way of example and not limitation) to determine, and perform beam management for a beam (e.g., 628) that is used by the UE 502 for communications with the base station 504. An R matrix estimate (e.g., 626 in FIG. 6) may be performed within a single SSB (e.g., 604 in FIG. 6; 704 in FIG. 7) to support faster performance for the UE 502 with up to six antenna elements in an antenna module (e.g., 602 in FIG. 6; 702 in FIG. 7).

At 916, the UE communicates, with the network node, using the first beam or the second beam based on at least one of the first measurement or the second measurement (e.g., based on the estimated RSRP). As an example, the communication may be performed, at least in part, by one or more of the component 198, the transceiver 1122, and/or the antenna 1180 in FIG. 11. FIGS. 5, 6 illustrate an example of the UE 502 communicating with a network node (e.g., the base station 504).

The UE 502 may be configured to communicate, with the network node (and vice versa), using the first beam or the second beam based on at least one of the first measurement or the second measurement. That is, in aspects, the UE 502 may be configured to provide/transmit communication(s) 512 to, and/or receive from, the base station 504 using a selected beam (e.g., 628 in FIG. 6) based on the beam measurements (e.g., at 508) and/or the estimation(s) (e.g., at 510).

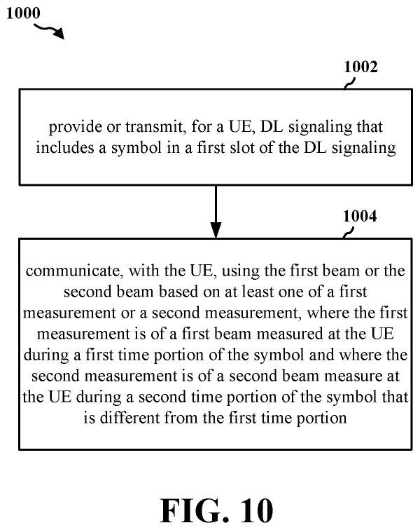

FIG. 10 is a flowchart 1000 of a method of wireless communication, in various aspects. The method may be performed by a network node (e.g., the base station 102. 504; the network entity 1102, 1202). In some aspects, the method may include aspects described in connection with the communication flow in FIG. 5 and/or aspects described in FIGS. 6, 7. The method may be for scheduling with a split symbol for beam management and enables the measurement of up to six beams per SSB by splitting the measured symbols into two halves or portions, where each part may be used to measure one beam, and enables speed increases, and reductions of latency and associated impacts, for beam measurements to mitigate cases of rotation, fading, and/or mobility for a UE by measuring up to six beams per SSB.

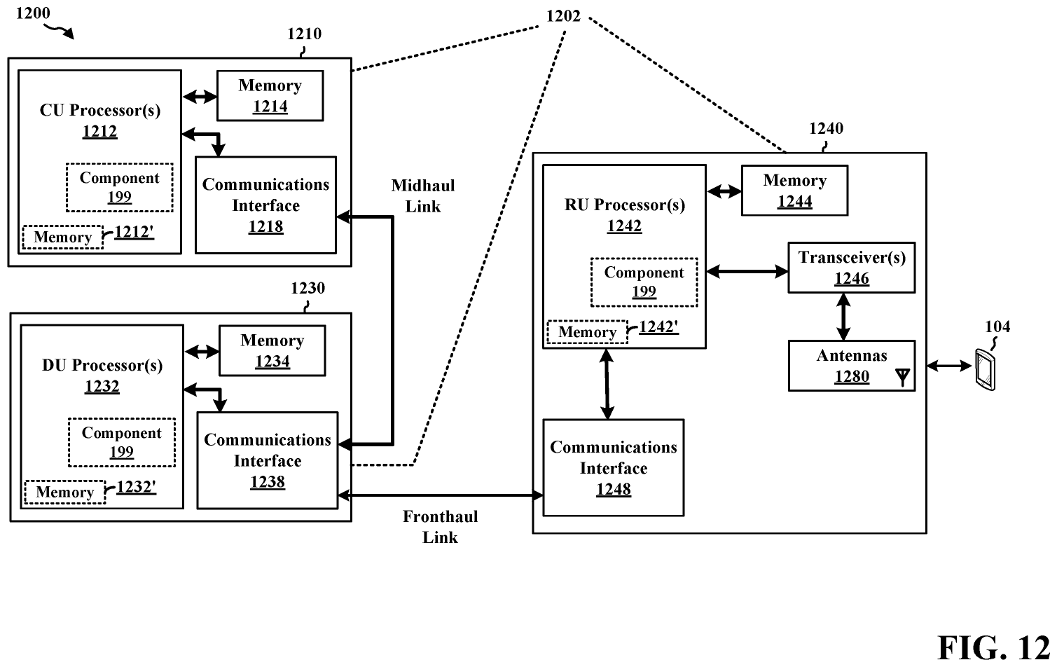

At 1002, the network node provides or transmits, for a UE, DL signaling that includes a symbol in a first slot of the DL signaling. As an example, the provision/transmission may be performed, at least in part, by one or more of the component 199, the transceiver(s) 1246, and/or the antenna(s) 1280 in FIG. 12. FIGS. 5-7 illustrate an example of the base station 504 providing or transmitting such DL signaling to a UE (e.g., the UE 502).

The UE 502 may be configured to receive DL signaling 506, which the base station 504 may be configured to transmit/provide. The DL signaling 506 may include a symbol. In aspects, the DL signaling may include one or more symbols in a slot of the DL signaling 506, and in aspects, may include symbols of an SSB (e.g., 604 in FIG. 6; 704 in FIG. 7) (e.g., a PSS, a first PBCH (e.g., 610 in FIG. 6; 710 in FIG. 7), a SSS (e.g., 612 in FIG. 6; 712 in FIG. 7), and a second PBCH (e.g., 614 in FIG. 6)). In some aspects, the first PBCH (e.g., 610 in FIG. 6; 710 in FIG. 7) may correspond to a first symbol, the SSS (e.g., 612 in FIG. 6; 712 in FIG. 7) may correspond to a second symbol, and the second PBCH may correspond to a third symbol. That is, the DL signaling 506 may comprise a SSB (e.g., 604 in FIG. 6; 704 in FIG. 7) that includes a first symbol comprising a PBCH (e.g., 610 in FIG. 6; 710 in FIG. 7), a second symbol comprising a SSS (e.g., 612 in FIG. 6; 712 in FIG. 7) and the PBCH, and a third symbol that includes the PBCH (e.g., 614 in FIG. 6). In aspects, the symbol received using the DL signaling 506 may correspond to the first symbol, the second symbol, or the third symbol of the SSB (e.g., 604 in FIG. 6; 704 in FIG. 7).

At 1004, the network node communicates, with the UE, using the first beam or the second beam based on at least one of a first measurement or a second measurement, where the first measurement is of a first beam measured at the UE during a first time portion of the symbol and where the second measurement is of a second beam measure at the UE during a second time portion of the symbol that is different from the first time portion. As an example, the communication may be performed, at least in part, by one or more of the component 199, the transceiver(s) 1246, and/or the antenna(s) 1280 in FIG. 12. FIGS. 5-7 illustrate an example of the base station 504 communicating with a UE (e.g., the UE 502).

In some aspects, the base station 504 may configure the UE 502 to measure (at 508) a first measurement of a first beam (e.g., 616, 620, 624 in FIG. 6; 716 in FIG. 7) at the UE 502 during a first time portion (e.g., 720 in FIG. 7) of the symbol and a second measurement of a second beam (e.g., 618, 622 in FIG. 6; 718 in FIG. 7) at the UE 502 during a second time portion (e.g., 722 in FIG. 7) of the symbol that is different from the first time portion (e.g., 720 in FIG. 7). In other words, the base station may configure the UE 502 to measure (at 508) two beams utilizing a single symbol. Accordingly, the UE 502 may be configured to perform up to six measurements for up to six beams (e.g., 616, 618, 620, 622, 624 in FIG. 6) during a single SSB (e.g., 604 in FIG. 6; 704 in FIG. 7) comprising three symbols that include a PBCH. In aspects for which up to six beams (e.g., 616, 618, 620, 622, 624 in FIG. 6) may be measured, a separate measurement for each of the up to six beams (e.g., 616, 618, 620, 622, 624 in FIG. 6) may be made. The beams measured (at 508) may respectively correspond to antenna elements of an antenna module/array (e.g., 602 in FIG. 6; 702 in FIG. 7) of the UE 502.

Further, the base station 504 may configured UE 502 to switch (e.g., 606 in FIG. 6; 706 in FIG. 7) beams during a symbol, e.g., split symbol scheduling). For example, a first beam (e.g., 616, 620, 624 in FIG. 6; 716 in FIG. 7) may be active for measurement over a first part of the symbol that corresponds to the first time portion (e.g., 720 in FIG. 7), and the second beam (e.g., 618, 622 in FIG. 6; 718 in FIG. 7) may be active over a different second part of the symbol that corresponds to the second time portion (e.g., 722 in FIG. 7). The UE 502 may be configured by the base station 504 to switch (e.g., 606 in FIG. 6; 706 in FIG. 7) from the first beam (e.g., 616, 620, 624 in FIG. 6; 716 in FIG. 7) to the second beam (e.g., 618, 622 in FIG. 6; 718 in FIG. 7) prior to an end of the second time portion (e.g., 722 in FIG. 7) associated with the symbol.

Additionally, the UE 502 may be configured by the base station 504 to measure a third beam and a fourth beam during a second symbol, and/or to measure at least a fifth beam during a third symbol. Correspondingly, the base station 504 may configured the UE 502 to perform the switch (e.g., 606 in FIG. 6; 706 in FIG. 7) from the third beam to the fourth beam during the second symbol. In aspects, a beam switching rate utilized by the UE 502 for scheduling with a split symbol for beam management may be configured, e.g., by the base station 504, as double the SCS for the DL signaling 506. As one example, if the DL signaling 506 has a SCS of, or approximately, 120 kHz, the UE 502 may be configured to switch (e.g., 606 in FIG. 6; 706 in FIG. 7) from one beam to another beam for a single symbol using a beam switch rate at a SCS of, or approximately, 240 kHz (e.g., at approximately double the signaling SCS).

The base station 504 may configured the UE 502 to estimate (at 510) a RSRP for at least one of the first beam (e.g., 616, 620, 624 in FIG. 6; 716 in FIG. 7) based on the first measurement or the second beam (e.g., 618, 622 in FIG. 6; 718 in FIG. 7) based on the second measurement. In aspects for which up to six beams (e.g., 616, 618, 620, 622. 624 in FIG. 6) may be measured, a separate estimate (at 510) one or more of the up to six beams (e.g., 616, 618, 620, 622, 624 in FIG. 6) may be made for each beam measured. The UE 502 may be configured by the base station 504 to utilize an R matrix estimate (e.g., 626 in FIG. 6) for the estimate (at 510). An R matrix estimate (e.g., 626 in FIG. 6) may be utilized for OSBM and/or CIR-based DYB (by way of example and not limitation) to determine, and perform beam management for a beam (e.g., 628) that is used by the UE 502 for communications with the base station 504. An R matrix estimate (e.g., 626 in FIG. 6) may be performed within a single SSB (e.g., 604 in FIG. 6; 704 in FIG. 7) to support faster performance for the UE 502 with up to six antenna elements in an antenna module (e.g., 602 in FIG. 6; 702 in FIG. 7).

The base station 504 may configure the UE 502 to communicate, with the network node (and vice versa), using the first beam or the second beam based on at least one of the first measurement or the second measurement. That is, in aspects, the UE 502 may be configured by the base station 504 to provide/transmit communication(s) 512 to, and/or receive from, the base station 504 using a selected beam (e.g., 628 in FIG. 6) based on the beam measurements (e.g., at 508) and/or the estimation(s) (e.g., at 510).

FIG. 11 is a diagram 1100 illustrating an example of a hardware implementation for an apparatus 1104. The apparatus 1104 may be a UE, a component of a UE, or may implement UE functionality. In some aspects, the apparatus 1104 may include at least one cellular baseband processor 1124 (also referred to as a modem) coupled to one or more transceivers 1122 (e.g., cellular RF transceiver). The cellular baseband processor(s) 1124 may include at least one on-chip memory 1124′. In some aspects, the apparatus 1104 may further include one or more subscriber identity modules (SIM) cards 1120 and at least one application processor 1106 coupled to a secure digital (SD) card 1108 and a screen 1110. The application processor(s) 1106 may include on-chip memory 1106′. In some aspects, the apparatus 1104 may further include a Bluetooth module 1112, a WLAN module 1114, an SPS module 1116 (e.g., GNSS module), one or more sensor modules 1118 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1126, a power supply 1130, and/or a camera 1132. The Bluetooth module 1112, the WLAN module 1114, and the SPS module 1116 may include an on-chip transceiver (TRX) (or in some cases, just a receiver (RX)). The Bluetooth module 1112, the WLAN module 1114, and the SPS module 1116 may include their own dedicated antennas and/or utilize the antennas 1180 for communication. The cellular baseband processor(s) 1124 communicates through the transceiver(s) 1122 via one or more antennas 1180 with the UE 104 and/or with an RU associated with a network entity 1102. The cellular baseband processor(s) 1124 and the application processor(s) 1106 may each include a computer-readable medium/memory 1124′, 1106′, respectively. The additional memory modules 1126 may also be considered a computer-readable medium/memory. Each computer-readable medium/memory 1124′, 1106′, 1126 may be non-transitory. The cellular baseband processor(s) 1124 and the application processor(s) 1106 are each responsible for general processing, including the execution of software stored on the computer-readable medium/memory. The software, when executed by the cellular baseband processor(s) 1124/application processor(s) 1106, causes the cellular baseband processor(s) 1124/application processor(s) 1106 to perform the various functions described supra. The computer-readable medium/memory may also be used for storing data that is manipulated by the cellular baseband processor(s) 1124/application processor(s) 1106 when executing software. The cellular baseband processor(s) 1124/application processor(s) 1106 may be a component of the UE 350 and may include the at least one memory 360 and/or at least one of the TX processor 368, the RX processor 356, and the controller/processor 359. In one configuration, the apparatus 1104 may be at least one processor chip (modem and/or application) and include just the cellular baseband processor(s) 1124 and/or the application processor(s) 1106, and in another configuration, the apparatus 1104 may be the entire UE (e.g., see UE 350 of FIG. 3) and include the additional modules of the apparatus 1104.

As discussed supra, the component 198 may be configured to receive, from a network node, DL signaling that includes a symbol in a first slot of the DL signaling. The component 198 may also be configured to measure a first measurement of a first beam at the UE during a first time portion of the symbol and a second measurement of a second beam at the UE during a second time portion of the symbol that is different from the first time portion. The component 198 may also be configured to communicate, with the network node, using the first beam or the second beam based on at least one of the first measurement or the second measurement. The component 198 may be configured to estimate a RSRP for at least one of the first beam based on the first measurement or the second beam based on the second measurement. The component 198 may be configured to communicate using a beam selected from the first beam or the second beam based on the estimated RSRP. The component 198 may be configured to switch from the first beam to the second beam prior to an end of the second time portion associated with the symbol. The component 198 may be configured to perform up to six measurements for up to six beams during a single SSB comprising three symbols that include a PBCH. The component 198 may be further configured to perform any of the aspects described in connection with the flowcharts in any of FIGS. 8, 9, 10, and/or any of the aspects performed by a UE for any of FIGS. 5-7. The component 198 may be within the cellular baseband processor(s) 1124, the application processor(s) 1106, or both the cellular baseband processor(s) 1124 and the application processor(s) 1106. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1104 may include a variety of components configured for various functions. In one configuration, the apparatus 1104, and in particular the cellular baseband processor(s) 1124 and/or the application processor(s) 1106, may include means for receiving, from a network node, DL signaling that includes a symbol in a first slot of the DL signaling. In the configuration, the apparatus 1104, and in particular the cellular baseband processor(s) 1124 and/or the application processor(s) 1106, may include means for measuring a first measurement of a first beam at the UE during a first time portion of the symbol and a second measurement of a second beam at the UE during a second time portion of the symbol that is different from the first time portion. In the configuration, the apparatus 1104, and in particular the cellular baseband processor(s) 1124 and/or the application processor(s) 1106, may include means for communicating, with the network node, using the first beam or the second beam based on at least one of the first measurement or the second measurement. In one configuration, the apparatus 1104, and in particular the cellular baseband processor(s) 1124 and/or the application processor(s) 1106, may include means for estimating a RSRP for at least one of the first beam based on the first measurement or the second beam based on the second measurement. In one configuration, the apparatus 1104, and in particular the cellular baseband processor(s) 1124 and/or the application processor(s) 1106, may include means for communicating using a beam selected from the first beam or the second beam based on the estimated RSRP. In one configuration, the apparatus 1104, and in particular the cellular baseband processor(s) 1124 and/or the application processor(s) 1106, may include means for switching from the first beam to the second beam prior to an end of the second time portion associated with the symbol. In one configuration, the apparatus 1104, and in particular the cellular baseband processor(s) 1124 and/or the application processor(s) 1106, may include means for performing up to six measurements for up to six beams during a single SSB comprising three symbols that include a PBCH. The means may be the component 198 of the apparatus 1104 configured to perform the functions recited by the means. As described supra, the apparatus 1104 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 12 is a diagram 1200 illustrating an example of a hardware implementation for a network entity 1202. The network entity 1202 may be a BS, a component of a BS, or may implement BS functionality. The network entity 1202 may include at least one of a CU 1210, a DU 1230, or an RU 1240. For example, depending on the layer functionality handled by the component 199, the network entity 1202 may include the CU 1210; both the CU 1210 and the DU 1230; each of the CU 1210, the DU 1230, and the RU 1240; the DU 1230; both the DU 1230 and the RU 1240; or the RU 1240. The CU 1210 may include at least one CU processor 1212. The CU processor(s) 1212 may include on-chip memory 1212′. In some aspects, the CU 1210 may further include additional memory modules 1214 and a communications interface 1218. The CU 1210 communicates with the DU 1230 through a midhaul link, such as an F1 interface. The DU 1230 may include at least one DU processor 1232. The DU processor(s) 1232 may include on-chip memory 1232′. In some aspects, the DU 1230 may further include additional memory modules 1234 and a communications interface 1238. The DU 1230 communicates with the RU 1240 through a fronthaul link. The RU 1240 may include at least one RU processor 1242. The RU processor(s) 1242 may include on-chip memory 1242′. In some aspects, the RU 1240 may further include additional memory modules 1244, one or more transceivers 1246, antennas 1280, and a communications interface 1248. The RU 1240 communicates with the UE 104. The on-chip memory 1212′, 1232′, 1242′ and the additional memory modules 1214, 1234, 1244 may each be considered a computer-readable medium/memory. Each computer-readable medium/memory may be non-transitory. Each of the processors 1212, 1232, 1242 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to provide or transmit, for a UE. DL signaling that includes a symbol in a first slot of the DL signaling. The component 199 may also be configured to communicate, with the UE, using a first beam or a second beam based on at least one of a first measurement or a second measurement, where the first measurement is of the first beam measured at the UE during a first time portion of the symbol and where the second measurement is of the second beam measures at the UE during a second time portion of the symbol that is different from the first time portion. The component 199 may be configured to operate in a commensurate manner with the component 198, as described herein. The component 199 may be further configured to perform any of the aspects described in connection with the flowcharts in any of FIGS. 8, 9, 10, and/or any of the aspects performed by a UE for any of FIGS. 5-7. The component 199 may be within one or more processors of one or more of the CU 1210, DU 1230, and the RU 1240. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1202 may include a variety of components configured for various functions. In one configuration, the network entity 1202 may include means for providing or transmitting, for a UE, DL signaling that includes a symbol in a first slot of the DL signaling. In the configuration, the network entity 1202 may include means for communicating, with the UE, using a first beam or a second beam based on at least one of a first measurement or a second measurement, where the first measurement is of the first beam measured at the UE during a first time portion of the symbol and where the second measurement is of the second beam measured at the UE during a second time portion of the symbol that is different from the first time portion. In one configuration, the network entity 1202 may include means for operating in a commensurate manner with the component 198, the apparatus 1104, the cellular baseband processor(s) 1124, and/or the application processor(s) 1106, as described herein. The means may be the component 199 of the network entity 1202 configured to perform the functions recited by the means. As described supra, the network entity 1202 may include the TX processor 316, the RX processor 370, and the controller/processor 375. As such, in one configuration, the means may be the TX processor 316, the RX processor 370, and/or the controller/processor 375 configured to perform the functions recited by the means.

In wireless communication networks, beam management may improve communications between a network node (e.g., a base station, gNB, etc.) and a UE. In some examples, a UE may measure a single beam for each symbol, e.g., using PBCH DMRS received in the symbol. If a PBCH is transmitted in two of the three symbols in a SSB, with an SSS therebetween (e.g., PBCH, SSS, PBCH), or a burst set thereof, the UE may measure three beams on the three symbols of the SSB. In some aspects, a OSBM and CIR based (DYB may utilize estimates of channel correlation R matrices to manage beams. However, such solutions may be less efficient for latency and/or for accuracy. That is, the single beam per symbol approach utilizes multiple SSBs to measure beams for a five-element antenna module, and using two SSBs for estimations of an R matrix for such an antenna module may have estimates that may be impacted due to channel changes associated with fading and/or UE mobility over the length of time for multiple SSBs to be received. For example, the delay for measurements over a second SSB may be vulnerable to a fading channel or may be affected by UE mobility, and the correlation for an R matrix may be estimated with degradation. The degradation in the estimation can impact the performance in beam tracking.

Aspects herein for scheduling with a split symbol for beam management enable the measurement of up to six beams per SSB by splitting the measured symbols into two halves or portions, where each part may be used to measure a different beam. Additionally, speeds are increased, and latency and associated impacts are reduced, for beam measurements by measuring up to six beams per SSB to mitigate cases of rotation, fading, and/or mobility for a UE. Thus, improvements for utilization of OSBM and DYB implementations may be achieved by estimating the RSRP of all static beams to generate a DYB with improved accuracy within a single SSB.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE), comprising: receiving, from a network node, downlink (DL) signaling that includes a symbol in a first slot of the DL signaling; measuring a first measurement of a first beam at the UE during a first time portion of the symbol and a second measurement of a second beam at the UE during a second time portion of the symbol that is different from the first time portion; and communicating, with the network node, using the first beam or the second beam based on at least one of the first measurement or the second measurement.

Aspect 2 is the method of aspect 1, further comprising: estimating a reference signal received power (RSRP) for at least one of the first beam based on the first measurement or the second beam based on the second measurement.

Aspect 3 is the method of aspect 2, wherein communicating using the first beam or the second beam based on at least one of the first measurement or the second measurement comprises: communicating using a beam selected from the first beam or the second beam based on the estimated RSRP.

Aspect 4 is the method of any of aspects 1 to 3, wherein the UE comprises at least a first antenna element and second antenna element; wherein the first beam is associated with the first antenna element and the second beam is associated with the second antenna element.

Aspect 5 is the method of any of aspects 1 to 4, wherein measuring the first measurement of the first beam at the UE during the first time portion of the symbol and the second measurement of the second beam at the UE during the second time portion of the symbol that is different from the first time portion comprises: switching from the first beam to the second beam prior to an end of the second time portion associated with the symbol.

Aspect 6 is the method of aspect 5, wherein the DL signaling further includes a second symbol and a third symbol, and wherein the measuring includes: measuring a third beam and a fourth beam during the second symbol; measuring at least a fifth beam during the third symbol; and performing additional switching from the third beam to the fourth beam during the second symbol.

Aspect 7 is the method of any of aspects 1 to 6, wherein the DL signaling is a synchronization signal block (SSB) that includes a first symbol comprising a physical broadcast channel (PBCH), a second symbol comprising a secondary synchronization signal (SSS), and a third symbol that includes the PBCH, wherein the symbol corresponds to the first symbol, the second symbol, or the third symbol of the SSB.

Aspect 8 is the method of any of aspects 1 to 7, wherein the DL signaling has a subcarrier spacing (SCS) of approximately 120 kHz; wherein switching from the first beam to the second beam prior to an end of the second time portion of the symbol comprises: switching from the first beam to the second beam using a beam switch rate at another SCS of approximately 240 kHz.

Aspect 9 is the method of any of aspects 1 to 8, further comprising: performing up to six measurements for up to six beams during a single synchronization signal block (SSB) comprising three symbols that include a physical broadcast channel (PBCH).

Aspect 10 is an apparatus for wireless communication including means for implementing any of aspects 1 to 9.

Aspect 11 is a computer-readable medium (e.g., a non-transitory computer-readable medium) storing computer executable code, the code when executed by at least one processor causes the at least one processor to implement any of aspects 1 to 9.

Aspect 12 is an apparatus for wireless communication at a network node. The apparatus includes a memory; and at least one processor coupled to the memory and, based at least in part on information stored in the memory, the at least one processor is configured to implement any of aspects 1 to 9.

Aspect 13 is the apparatus of aspect 12, further including at least one of a transceiver or an antenna coupled to the at least one processor.

Aspect 14 is an apparatus for wireless communication at a UE, comprising: at least one memory; and at least one processor coupled to the at least one memory and, based at least in part on information stored in the at least one memory, the at least one processor, individually or in any combination, is configured to perform the method of any of aspects 1 to 9.

Aspect 15 is an apparatus for wireless communication at a UE, comprising means for performing each step in the method of any of aspects 1 to 9.

Aspect 16 is the apparatus of any of aspects 14 and 15, further comprising a transceiver configured to receive or to transmit or to communicate in association with the method of any of aspects 1 to 9.

Aspect 17 is a computer-readable medium storing computer executable code at a UE, the code when executed by at least one processor causes the at least one processor to perform the method of any of aspects 1 to 9.

Aspect 18 is a method of wireless communication at a network node, comprising: providing or transmitting, for a UE, DL signaling that includes a symbol in a first slot of the DL signaling; and communicating, with the UE, using the first beam or the second beam based on at least one of a first measurement or a second measurement, wherein the first measurement is of a first beam measured at the UE during a first time portion of the symbol and wherein the second measurement is of a second beam measure at the UE during a second time portion of the symbol that is different from the first time portion.

Aspect 19 is an apparatus for wireless communication including means for implementing aspect 18.

Aspect 20 is a computer-readable medium (e.g., a non-transitory computer-readable medium) storing computer executable code, the code when executed by at least one processor causes the at least one processor to implement aspect 18.

Aspect 21 is an apparatus for wireless communication at a network node. The apparatus includes a memory; and at least one processor coupled to the memory and, based at least in part on information stored in the memory, the at least one processor is configured to implement aspect 18.

Aspect 22 is the apparatus of aspect 21, further including at least one of a transceiver or an antenna coupled to the at least one processor.

Aspect 23 is an apparatus for wireless communication at a UE, comprising: at least one memory; and at least one processor coupled to the at least one memory and, based at least in part on information stored in the at least one memory, the at least one processor, individually or in any combination, is configured to perform the method of aspect 18.

Aspect 24 is an apparatus for wireless communication at a UE, comprising means for performing each step in the method of aspect 18.

Aspect 25 is the apparatus of any of aspects 23 and 24, further comprising a transceiver configured to receive or to transmit or to communicate in association with the method of aspect 18.

Aspect 26 is a computer-readable medium storing computer executable code at a UE, the code when executed by at least one processor causes the at least one processor to perform the method of aspect 18.

What is claimed is:

1. An apparatus for wireless communication at a user equipment (UE), comprising:
at least one memory; and
at least one processor coupled to the at least one memory and, based at least in part on information stored in the at least one memory, the at least one processor, individually or in any combination, is configured to:
receive, from a network node, downlink (DL) signaling that includes a symbol in a first slot of the DL signaling;
measure a first measurement of a first beam at the UE during a first time portion of the symbol and a second measurement of a second beam at the UE during a second time portion of the symbol that is different from the first time portion; and
communicate, with the network node, using the first beam or the second beam based on at least one of the first measurement or the second measurement.

2. The apparatus of claim 1, wherein the at least one processor, individually or in any combination, is further configured to:
estimate a reference signal received power (RSRP) for at least one of the first beam based on the first measurement or the second beam based on the second measurement.

3. The apparatus of claim 2, wherein to communicate using the first beam or the second beam based on at least one of the first measurement or the second measurement, the at least one processor, individually or in any combination, is configured to:
communicate using a beam selected from the first beam or the second beam based on the estimated RSRP.

4. The apparatus of claim 1, wherein the apparatus comprises at least a first antenna element and second antenna element;
wherein the first beam is associated with the first antenna element and the second beam is associated with the second antenna element.

5. The apparatus of claim 4, further comprising at least one transceiver coupled to the at least one processor, the first antenna element, and the second antenna element, the at least one processor being configured to:
receive the DL signaling and communicate with the network node via the at least one transceiver.

6. The apparatus of claim 1, wherein to measure the first measurement of the first beam at the UE during the first time portion of the symbol and the second measurement of the second beam at the UE during the second time portion of the symbol that is different from the first time portion, the at least one processor, individually or in any combination, is configured to:
switch from the first beam to the second beam prior to an end of the second time portion associated with the symbol.

7. The apparatus of claim 6, wherein the DL signaling further includes a second symbol and a third symbol, and wherein to measure, the at least one processor, individually or in any combination, is configured to:
measure a third beam and a fourth beam during the second symbol;
measure at least a fifth beam during the third symbol; and
perform an additional switch from the third beam to the fourth beam during the second symbol.

8. The apparatus of claim 1, wherein the DL signaling comprises a synchronization signal block (SSB) that includes a first symbol comprising a physical broadcast channel (PBCH), a second symbol comprising a secondary synchronization signal (SSS), and a third symbol that includes the PBCH, wherein the symbol corresponds to the first symbol, the second symbol, or the third symbol of the SSB.

9. The apparatus of claim 1, wherein the DL signaling has a subcarrier spacing (SCS) of approximately 120 kHz;
wherein to switch from the first beam to the second beam prior to an end of the second time portion of the symbol, the at least one processor, individually or in any combination, is configured to:
switch from the first beam to the second beam using a beam switch rate at another SCS of approximately 240 KHz.

10. The apparatus of claim 1, wherein the at least one processor, individually or in any combination, is further configured to:
perform up to six measurements for up to six beams during a single synchronization signal block (SSB) comprising three symbols that include a first physical broadcast channel (PBCH), a secondary synchronization signal (SSS), and a second PBCH.

11. A method of wireless communication at a user equipment (UE), comprising:
receiving, from a network node, downlink (DL) signaling that includes a symbol in a first slot of the DL signaling;
measuring a first measurement of a first beam at the UE during a first time portion of the symbol and a second measurement of a second beam at the UE during a second time portion of the symbol that is different from the first time portion; and
communicating, with the network node, using the first beam or the second beam based on at least one of the first measurement or the second measurement.

12. The method of claim 11, further comprising:
estimating a reference signal received power (RSRP) for at least one of the first beam based on the first measurement or the second beam based on the second measurement.

13. The method of claim 12, wherein communicating using the first beam or the second beam based on at least one of the first measurement or the second measurement comprises:
communicating using a beam selected from the first beam or the second beam based on the estimated RSRP.

14. The method of claim 11, wherein the UE comprises at least a first antenna element and second antenna element;
wherein the first beam is associated with the first antenna element and the second beam is associated with the second antenna element.

15. The method of claim 11, wherein measuring the first measurement of the first beam at the UE during the first time portion of the symbol and the second measurement of the second beam at the UE during the second time portion of the symbol that is different from the first time portion comprises:
switching from the first beam to the second beam prior to an end of the second time portion associated with the symbol.

16. The method of claim 15, wherein the DL signaling further includes a second symbol and a third symbol, and wherein the measuring includes:
measuring a third beam and a fourth beam during the second symbol;
measuring at least a fifth beam during the third symbol; and
switching from the third beam to the fourth beam during the second symbol.

17. The method of claim 11, wherein the DL signaling is a synchronization signal block (SSB) that includes a first symbol comprising a physical broadcast channel (PBCH), a second symbol comprising a secondary synchronization signal (SSS), and a third symbol that includes the PBCH, wherein the symbol corresponds to the first symbol, the second symbol, or the third symbol of the SSB.

18. The method of claim 11, wherein the DL signaling has a subcarrier spacing (SCS) of approximately 120 kHz;
wherein switching from the first beam to the second beam prior to an end of the second time portion of the symbol comprises:
switching from the first beam to the second beam using a beam switch rate at another SCS of approximately 240 KHz.

19. The method of claim 11, further comprising:
performing up to six measurements for up to six beams during a single synchronization signal block (SSB) comprising three symbols that include a first physical broadcast channel (PBCH), a secondary synchronization signal (SSS), and a second PBCH.

20. A apparatus for wireless communication at a user equipment (UE), comprising:
means for receiving, from a network node, downlink (DL) signaling that includes a symbol in a first slot of the DL signaling;
means for measuring a first measurement of a first beam at the UE during a first time portion of the symbol and a second measurement of a second beam at the UE during a second time portion of the symbol that is different from the first time portion; and
means for communicating, with the network node, using the first beam or the second beam based on at least one of the first measurement or the second measurement.

21. The apparatus of claim 20, further comprising:
means for estimating a reference signal received power (RSRP) for at least one of the first beam based on the first measurement or the second beam based on the second measurement.

22. The apparatus of claim 21, wherein the means for communicating using the first beam or the second beam based on at least one of the first measurement or the second measurement comprise:
means for communicating using a beam selected from the first beam or the second beam based on the estimated RSRP.

23. The apparatus of claim 20, wherein the apparatus comprises at least a first antenna element and second antenna element;
wherein the first beam is associated with the first antenna element and the second beam is associated with the second antenna element.

24. The apparatus of claim 23, further comprising at least one transceiver coupled to the first antenna element and the second antenna element, and means for:
receiving the DL signaling and communicating with the network node via the at least one transceiver.

25. The apparatus of claim 20, wherein the means for measuring the first measurement of the first beam at the UE during the first time portion of the symbol and the second measurement of the second beam at the UE during the second time portion of the symbol that is different from the first time portion comprise:
means for switching from the first beam to the second beam prior to an end of the second time portion associated with the symbol.

26. The apparatus of claim 25, wherein the DL signaling further includes a second symbol and a third symbol, and wherein the means for measuring include:
means for measuring a third beam and a fourth beam during the second symbol;
means for measuring at least a fifth beam during the third symbol; and
means for performing switching from the third beam to the fourth beam during the second symbol.

27. The apparatus of claim 20, wherein the DL signaling comprises a synchronization signal block (SSB) that includes a first symbol comprising a physical broadcast channel (PBCH), a second symbol comprising a secondary synchronization signal (SSS), and a third symbol that includes the PBCH, wherein the symbol corresponds to the first symbol, the second symbol, or the third symbol of the SSB.

28. The apparatus of claim 20, wherein the DL signaling has a subcarrier spacing (SCS) of approximately 120 kHz;
wherein the means for switching from the first beam to the second beam prior to an end of the second time portion of the symbol comprise:
means for switching from the first beam to the second beam using a beam switch rate at another SCS of approximately 240 KHz.

29. The apparatus of claim 20, further comprising:
means for performing up to six measurements for up to six beams during a single synchronization signal block (SSB) comprising three symbols that include a first physical broadcast channel (PBCH), a secondary synchronization signal (SSS), and a second PBCH.

30. A computer-readable medium storing computer executable code at a user equipment (UE), the code when executed by at least one processor causes the at least one processor, individually or in any combination, to:
receive, from a network node, downlink (DL) signaling that includes a symbol in a first slot of the DL signaling;
measure a first measurement of a first beam at the UE during a first time portion of the symbol and a second measurement of a second beam at the UE during a second time portion of the symbol that is different from the first time portion; and
communicate, with the network node, using the first beam or the second beam based on at least one of the first measurement or the second measurement.
